(19) United States
(12) Patent Application Publication
(10) Pub. No.: US 2018/0292590 A1
(43) Pub. Date: Oct. 11, 2018

(54) RETARDATION FILM AND FABRICATING METHOD THEREOF, AND DISPLAY DEVICE

(71) Applicants: BOE TECHNOLOGY GROUP CO., LTD., Beijing (CN); Chengdu BOE Optoelectronics Technology Co., Ltd., Chengdu, Sichuan (CN)

(72) Inventors: Xiongcan Zuo, Beijing (CN); Junrui Zhang, Beijing (CN); Yuanming Feng, Beijing (CN); Wenhua Song, Beijing (CN)

(73) Assignees: BOE TECHNOLOGY GROUP CO., LTD., Beijing (CN); Chengdu BOE Optoelectronics Technology Co., Ltd., Chengdu, Sichuan (CN)

(21) Appl. No.: 15/567,214

(22) PCT Filed: May 3, 2017
(86) PCT No.: PCT/CN2017/082878

§ 371 Date: Oct. 17, 2017

(30) Foreign Application Priority Data
Oct. 19, 2016 (CN) 201610911732.5

(51) Int. Cl. G02B 5/30; G02F 1/1335; G02F 1/13363

(52) U.S. Cl. CPC G02B 5/3016; G02F 1/133528; G02F 2001/133531; G02F 2001/133633; G02F 1/13363

(57) ABSTRACT

A retardation film and a fabricating method thereof, and a related display device are provided. In some embodiments, the retardation film includes: an alignment layer; and a liquid crystal polymer layer on the alignment layer and formed by polymerizing and curing reactive mesogens. The reactive mesogens include a plurality of reactive liquid crystal molecules having perpendicular orientations.

### CROSS-REFERENCES TO RELATED APPLICATIONS

This application claims the priority of Chinese Patent Application No. 201610911732.5, filed on Oct. 19, 2016, the entire content of which is incorporated herein by reference.

### FIELD OF THE DISCLOSURE

The present disclosure generally relates to the field of display technology and, more particularly, relates to a retardation film, a fabricating method thereof, and a related display device.

### BACKGROUND

When a display screen is viewed at a wide angle, the bright dark contrast of the display screen may be decreased to cause distortion of images displayed on the display screen. The viewing angle includes a range of acceptable viewing angles. The viewing angle of a liquid crystal display (LCD) is an important parameter for evaluating the display effect of the liquid crystal display.

In order to improve the display contrast of an LCD, it is important to suppress the light leakage in a black display state. When the LCD is viewed in a direction perpendicular to the display screen plane, the angle between polarization axes of the upper and lower polarizers is exactly 90 degrees. Therefore, the general performance of the LCD for displaying in a black display state is desirable without any light leakage phenomenon.

However, when the LCD is viewed from a direction oblique to the direction perpendicular to the display screen plane, that is, in an oblique viewing direction, the angle between polarization axes of the upper and lower polarizes is greater than 90 degrees. Due to the birefringence, the LCD may have a light leakage phenomenon, resulting in a low contrast, a limited view, a reduced display quality in the oblique viewing direction.

The present disclosure provides a retardation film, a fabricating method thereof, and a related display device to solve one or more problems set forth above and other problems.

### BRIEF SUMMARY OF THE DISCLOSURE

In accordance with some embodiments of the present disclosure, a retardation film, a fabricating method thereof, and a related display device are provided.

One aspect of present disclosure provides a retardation film, including: an alignment layer; and a liquid crystal polymer layer on the alignment layer and formed by polymerizing and curing reactive mesogens. The reactive mesogens include a plurality of reactive liquid crystal molecules having perpendicular orientations.

In some embodiments, an orientation of a first portion of the plurality of reactive liquid crystal molecules is parallel to a surface of the alignment layer; and an orientation of a second portion of the plurality of reactive liquid crystal molecules is perpendicular to the surface of the alignment layer.

In some embodiments, a material of the alignment layer is polyvinyl alcohol or polyimide.

In some embodiments, each reactive liquid crystal molecule includes a polymerizable group, and a rod-shaped liquid crystal group or a plate-shaped liquid crystal group.

In some embodiments, each reactive liquid crystal molecule includes a plurality of rod-shaped liquid crystal groups that are directly connected to each other, or connected with each other via linking groups.

In some embodiments, the plurality of rod-shaped liquid crystal groups include one or more aromatic groups or cycloaliphatic groups.

In some embodiments, each reactive liquid crystal molecule includes an end group and at least one side group; and the end group and the at least one side groups are selected from divalent carbon groups, hydrocarbyl groups, polar groups, nitro groups, hydroxyl groups, and polymerizable groups.

In some embodiments, the first portion of the plurality of reactive liquid crystal molecules are located in a plurality of first regions of the liquid crystal polymer layer; the second portion of the plurality of reactive liquid crystal molecules are located in a plurality of second regions of the liquid crystal polymer layer; the first regions and the second regions are arranged alternatively.

In some embodiments, a summation of a thickness of the alignment layer and the liquid crystal polymer layer is between about 2 μm and about 5 μm.

Another aspect of the present disclosure provides a method for fabricating a retardation film, including: preparing an alignment layer on a substrate; coating a reactive liquid crystal layer on the alignment layer; performing a first alignment process to the reactive liquid crystal layer, such that an orientation of a plurality of reactive liquid crystal molecules in the reactive liquid crystal layer is parallel to a surface of the alignment layer; performing a second alignment process to the reactive liquid crystal layer, such that an orientation of a sub-set of the plurality of reactive liquid crystal molecules in the reactive liquid crystal layer is perpendicular to the surface of the alignment layer; and fixing the alignment of the reactive liquid crystal to form a liquid crystal polymer layer, on the alignment layer.

In some embodiments, the first alignment process includes: irradiating the reactive liquid crystal layer by a linearly polarized ultraviolet light to align the orientation of the reactive liquid crystal molecules to be parallel to the surface of the alignment layer.

In some embodiments, the second alignment process includes: applying an electric field perpendicular to the alignment layer to a partial region of the reactive liquid crystal layer including the sub-set of the plurality of reactive liquid crystal molecules, such that the orientation of the sub-set of the plurality of reactive liquid crystal molecules is perpendicular to the surface of the alignment layer.

In some embodiments, the electric field is applied by using a plurality of silt electrodes; and an intensity of the electric field is equal to or higher than a saturation voltage of the reactive liquid crystal.

In some embodiments, the intensity of the electric field is within a range from about 4V to about 7V.

In some embodiments, fixing the alignment of the reactive liquid crystal includes: performing an ultraviolet curing process at a constant temperature to fix the alignment of the reactive liquid crystal.

In some embodiments, the constant temperature is within a range from about 100° C. to about 130° C.

In some embodiments, the ultraviolet curing process is performed in a nitrogen environment.

Another aspect of the present disclosure provides a display device, including: an upper polarizer, a lower polarizer; a liquid crystal display panel between the upper polarizer and the lower polarizer; and a retardation film between the upper polarizer and the lower polarizer, including: an alignment layer, and a liquid crystal polymer layer on the alignment layer and formed by polymerizing and curing reactive mesogens that include a plurality of reactive liquid crystal molecules having perpendicular orientations.

In some embodiments, the retardation film is between the upper polarizer and the liquid crystal display panel; a direction of an absorption axis of the upper polarizer is perpendicular to the orientations of liquid crystal molecules in the liquid crystal panel; and a direction of an absorption axis of the lower polarizer is parallel to the orientations of liquid crystal molecules in the liquid crystal panel.

In some embodiments, the retardation film is between the lower polarizer and the liquid crystal display panel; a direction of an absorption axis of the upper polarizer is parallel to the orientations of liquid crystal molecules in the liquid crystal panel; and a direction of an absorption axis of the lower polarizer is perpendicular to the orientations of liquid crystal molecules in the liquid crystal panel.

Other aspects of the present disclosure can be understood by those skilled in the art in light of the description, the claims, and the drawings of the present disclosure.

### BRIEF DESCRIPTION OF THE DRAWINGS

Various objectives, features, and advantages of the present disclosure can be more fully appreciated with reference to the detailed description of the present disclosure when considered in connection with the following drawings, in which like reference numerals identify like elements. It should be noted that the following drawings are merely examples for illustrative purposes according to various disclosed embodiments and are not intended to limit the scope of the present disclosure.

FIG. 1 illustrates a schematic structural diagram of a display device having an oblique viewing angle compensation structure;

FIG. 2 illustrates a schematic structural diagram of a +A film and a +C film;

FIG. 3 illustrates a graph of a viewing angle range of the display device shown in FIG. 1;

FIG. 4 illustrates a schematic structural diagram of another display device having an oblique viewing angle compensation structure;

FIG. 5 illustrates a graph of a viewing angle range of the display device shown in FIG. 4;

FIG. 6 illustrates a schematic structural diagram of a liquid crystal display device without a retardation film;

FIG. 7 illustrates a graph of a viewing angle range of the liquid crystal display shown in FIG. 6;

FIG. 8 illustrates a schematic structural diagram of an exemplary retardation film in accordance with some embodiments of the present disclosure;

FIG. 9 illustrates a schematic structural diagram of an exemplary retardation film in a certain fabricating stage when an alignment of reactive liquid crystal molecules is to be adjusted in accordance with some embodiments of the present disclosure;

FIG. 10 illustrates a schematic structural diagram of an exemplary display device in accordance with some embodiments of the present disclosure;

FIG. 11 illustrates a schematic structural diagram of another exemplary display device in accordance with some other embodiments of the present disclosure; and

FIG. 12 illustrates a schematic flow diagram of an exemplary fabricating process of a retardation film in accordance with some embodiments of the present disclosure.

### DETAILED DESCRIPTION

Reference input now be made in detail to exemplary embodiments of the invention, which are illustrated in the accompanying drawings in order to fully understand and being able to implementing the present disclosure and to realizing the technical effect. It should be understood that the following description has been made only by way of example, but not to limit the present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

Different display modes of liquid crystal displays (LCDs) can use different retardation films. For LCDs having advertising display screen (ADS) display mode that often have a light leakage problem at an oblique viewing angle, a single-layer retardation film or a two-layer retardation film can be added to a polarizer to achieve an optical compensation of the oblique viewing angle.

A single-layer retardation film, such as a Z plate, can be typically a film made of cyclic olefin polymer (COP) resin. The COP resin can be derived from oils and lipids obtained through animal, plant and mineral lines. The COP resin may have a weak resistance to organic solvents, including alcohol, isopropyl alcohol (IPA), etc., and to other physical damages. For example, once wiped by an organic solvent, the COP resin may be prone to fracture in a harsh environment. Therefore, the COP resin made single-layer retardation film may cause a poor display effect.

Further, in order to achieve the compensation effect, the single-layer retardation film is required to have a large thickness, e.g., about 150 microns, to achieve the desired phase retardation.

The two-layer retardation film can be a positive double-tortuous uniaxial A-plate (hereinafter “+A film”), a positive double-tortuous uniaxial C-plate (hereinafter “+C film”), and any other suitable two-layer retardation films. For the +A film, nₓ>n_{y}=n_{z}. And for +C film, n_{z}>n_{y}=nₓ. The axial directions of the crystal of the +A film and the crystal of the +C film are perpendicular to each other. Therefore, the angle between polarization axes of the upper and lower polarizes can be complemented to reduce the LA light leakage at the oblique viewing angle, thus widening the viewing angle.

Generally, a two-layer retardation film can have a thickness from about 30 microns to about 70 microns. However, the two-layer retardation film may be prone to delamination in a harsh environment, resulting in a poor display effect.

When a retardation film and a liquid crystal display panel is combined together to form a display device, for illustration purposes, the arrangement angle of the liquid crystal molecules in the liquid crystal display panel is about 90 degrees. That is, the length axes of the liquid crystal molecules in the liquid crystal panel can be parallel to the surface of the liquid crystal panel, and can be perpendicular to the direction of the absorption axis of the upper polarizer.

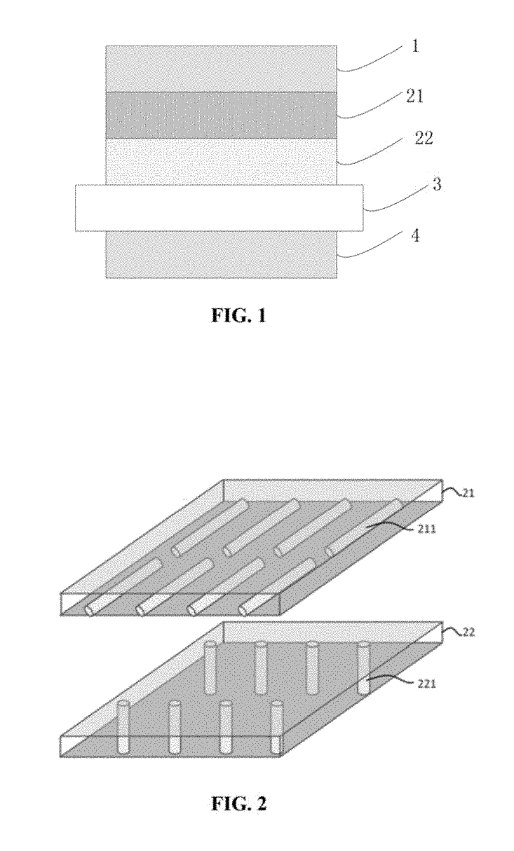

Referring to FIG. 1, a schematic structural diagram of an advertising display screen (ADS) mode display device having an oblique viewing angle compensation structure is shown. The direction of the absorption axis of the upper polarizer 1 can be defined as 0 degree. The direction of the absorption axis of the lower polarizer 4 can be defined as 90 degrees. The directions of the absorption axes of the upper polarizer and the lower polarizer can be perpendicular to each other.

In the +A film 21, the rod-shaped molecules after alignment can have a same orientation as the liquid crystal molecules in the ADS liquid crystal panel, which can be defined as 90 degrees. The orientation of liquid crystal molecules in the liquid crystal display panel can be in the direction of the major axis of the liquid crystal molecules which is parallel to the surface of the liquid crystal display panel, and is perpendicular to the direction of the absorption axis of the upper polarizer.

In the +C film 22, the rod-shaped molecules after alignment can have an orientation that is perpendicular to the orientation of the rod-shaped molecules in +A film 21 in the cubic plane after alignment.

The +C film 22 and the +A film 21 can be superimposed with one another. In an oblique viewing angle, the orientations of the rod-shaped molecules in +C film 22 and the rod-shaped molecules in +A film 21 in the cubic plane can be almost perpendicular to each other after alignment. Such alignment can compensate the angle between polarization axes of the upper and lower polarizers to make the angle to close to 90 degrees.

The rod-shaped polymer molecules in the +A film and the +C film can be arranged perpendicularly to each other. At an oblique viewing angle in the three-dimensional space, the rod-shaped polymer molecules in the +A film and the +C film also have an approximately vertical relationship. Further, a phase retardation between the rod-shaped polymer molecules in the +A film and the +C film in a positive viewing angle can be 0.

Referring to FIG. 2, a schematic structural diagram of a +A film and a +C film is shown. In the +A film 21, the rod-shaped polymer molecules 221 after alignment can have a same orientation as the liquid crystal molecules in the ADS liquid crystal panel. In the +C film 22, the rod-shaped polymer molecules 222 after alignment can have an orientation that is perpendicular to the orientation of the rod-shaped molecules in +A film 21 in the cubic plane after alignment.

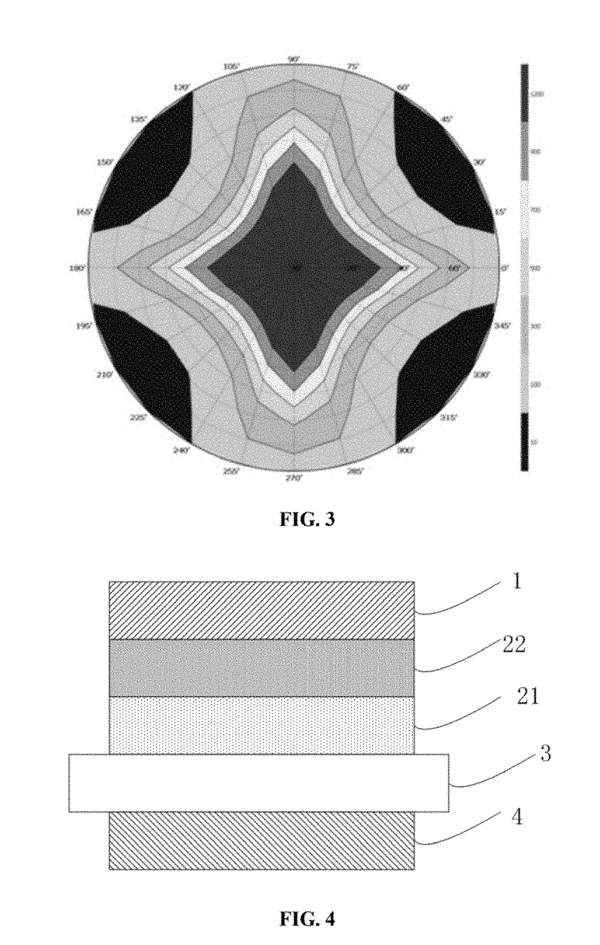

Referring to FIG. 3, a graph of a viewing angle range of the display device shown in FIG. 1 is illustrated. The range of viewing angles of the display device can be obtained by simulation, e.g., by using the Tech-Wiz software.

Referring to FIG. 4, a schematic structural diagram of another display device having an oblique viewing angle compensation structure is shown. The direction of the absorption axis of the upper polarizer 1 can be 0 degree. The direction of the absorption axis of the lower polarizer 4 can be 90 degrees.

The +A film 21 can be located between the +C film 22 and the liquid crystal panel 3. In the +A film 21, the orientation of the rod-shaped polymer molecules after alignment can be parallel to the surface of the liquid crystal panel 3, and can be perpendicular to the orientation of the liquid crystal molecules in the ADS liquid crystal panel. That is, the orientation of the rod-shaped polymer molecules in the +A film 21 can be 0 degree. And the orientation of the liquid crystal molecules in the ADS liquid crystal panel can be 90 degrees.

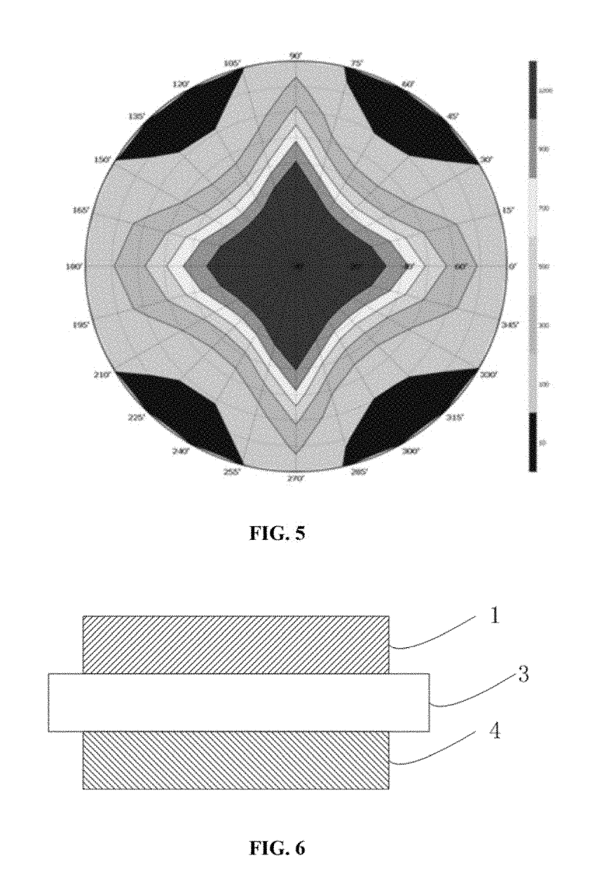

Referring to FIG. 5, a graph of a viewing angle range of the display device shown in FIG. 4 is illustrated. The range of viewing angles of the display device can be obtained by simulation, e.g., by using the Tech-Wiz software.

Referring to FIG. 6, a schematic structural diagram of a liquid crystal display device without a retardation film is shown. The liquid crystal display device without a retardation film can include an upper polarizer 1, a liquid crystal panel 3 and a lower polarizer 4 arranged sequentially.

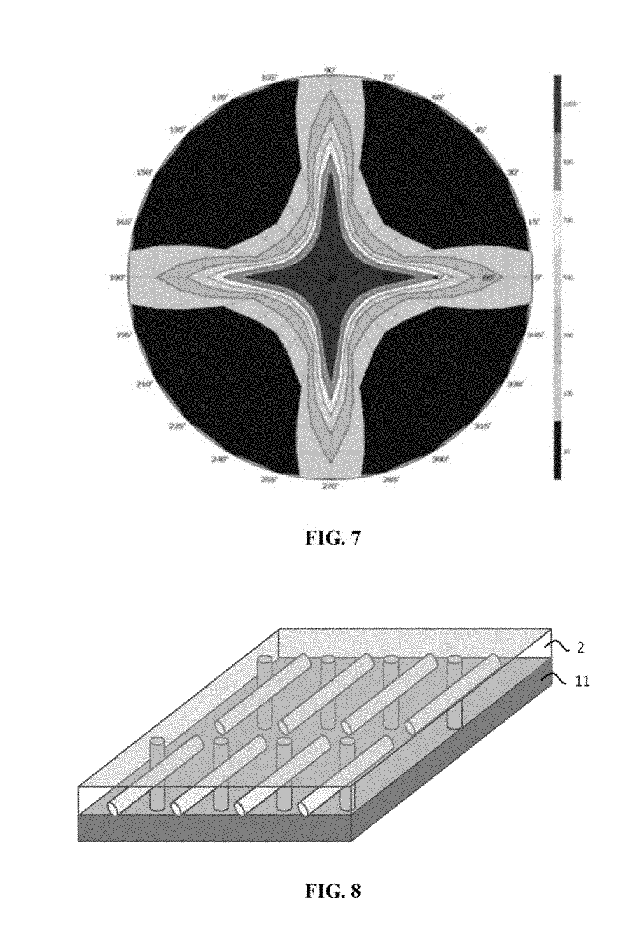

Referring to FIG. 7, a graph of a viewing angle range of the display device shown in FIG. 6 is illustrated. The range of viewing angles of the display device can be obtained by simulation, e.g., by using the Tech-Wiz software. As illustrated, the viewing angle range liquid crystal display device without a retardation film can be small.

As can be seen from FIGS. 3, 5 and 7, the liquid crystal display device having a retardation film including a +A film and a +C film can have a large field of view. The retardation film including the +A film and the +C film can compensate the oblique viewing angle.

In accordance with various embodiments, the present disclosure provides a retardation film, a fabricating method thereof, and a related display device. The disclose retardation film is a single-layer retardation film, which is capable of compensating the oblique viewing angle without delaminating or fracturing.

Referring to FIG. 8, a schematic structural diagram of an exemplary retardation film is shown in accordance with some embodiments of the present disclosure. As illustrated, the retardation film can include an alignment layer 11 and a liquid crystal polymer layer 2 on the alignment layer 11.

The alignment layer 11 can be used to perform a preliminary alignment of the liquid crystal molecules. The alignment layer 11 may be made of polyvinyl alcohol or polyimide.

The liquid crystal polymer layer 2 can be formed by polymerizing and curing reactive mesogens that include molecules having perpendicular orientations. In some embodiments, the orientation of a part of the molecules of the reactive mesogens can be parallel to the surface of the alignment layer 11, and the orientation of another part of the molecules of the reactive mesogens can be perpendicular to the surface of the alignment layer 11.

The reactive mesogens can be a liquid crystal compound including a polymerizable group, and a rod-shaped or plate-shaped liquid crystal group. In some embodiments, the reactive mesogens including a rod-shaped liquid crystal group can have an orientation in a direction of the long axis of the rod-shaped liquid crystal molecules.

Each rod-shaped reactive mesogen can generally include multiple rod-shaped liquid crystal groups including one or more aromatic or cycloaliphatic groups. The multiple rod-shaped liquid crystal groups can be directly connected to each other, or connected with each other via linking groups. It should be noted that, the rod-shaped liquid crystal groups are also called slat-shaped liquid crystal groups.

Each rod-shaped reactive mesogen can also include an end group attached to the short end of the rod, and one or more side groups attached to the long side of the rod. The end group and side groups can be selected from divalent carbon groups, hydrocarbyl groups, polar groups such as halogens, nitro groups, hydroxyl groups, polymerizable groups, and any other suitable groups.

In some embodiments, the reactive liquid mesogens can be represented by the following chemical formulas:

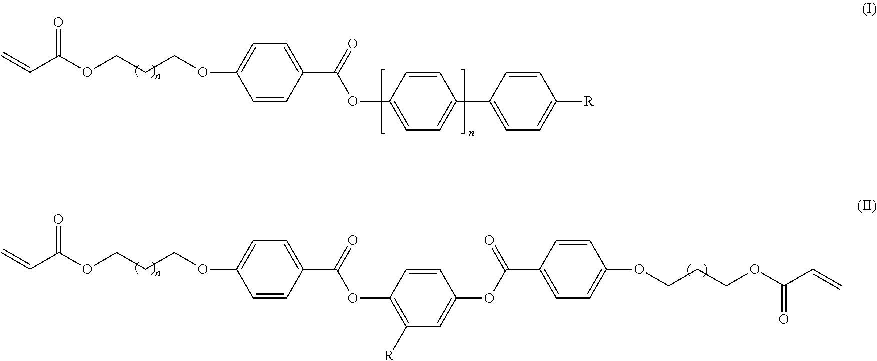

N is an integer form 0 to 12, and R may be a hydrogen atom, a methyl group, or a halogen atom.

In some embodiments, the reactive liquid mesogens can be provided by Merck & Co., Inc.

The reactive mesogens can be aligned to form a precise alignment state in which the orientations of the molecules are perpendicular to each other. And then the reactive mesogens in the precise alignment state can be solidified by polymerizing and curing to fix the structure.

In some embodiments, the formed liquid crystal polymer layer 2 can include a first liquid crystal polymer having an orientation in a vertical direction, which can be equivalent to a +C film. The formed liquid crystal polymer layer 2 can further include a second liquid crystal polymer having an orientation in a horizontal direction, which can be equivalent to a +A film.

Therefore, at an oblique viewing angle, the reactive liquid crystal polymer having the molecules oriented perpendicularly to each other can compensate the oblique viewing angle.

In some embodiments, a thickness of the retardation film can be within a range from about 2 μm to about 5 μm. Thus, the retardation film can have a desirable lightweight, and does not exhibit delamination and fracture.

Another aspect of the present disclosed provides a fabricating method of the disclosed retardation film described above. Referring to FIG. 12, a schematic flow diagram of an exemplary fabricating process of a retardation film is shown in accordance with some embodiments of the present disclosure. As illustrated, the fabricating process can include the following exemplary steps.

At step 1210, an alignment layer 11 can be provided on a substrate.

In some embodiments, the substrate may be a glass, a quartz, a triacetate (TAC) film of a polarizer, or any other suitable substrate. The substrate can act as a support to facilitate the preparation of the alignment layer 11 and the subsequently formed liquid crystal polymer layer 2, and can be peeled off after the preparation is completed.

A material of the alignment layer 11 may be, but is not limited to, polyvinyl alcohol or polyimide. In some embodiments, the material of the alignment layer can be a polyvinyl alcohol having a modified property by a water-transporting group. A process for preparing the alignment layer 11 can be a gravure coating method, a wire coating method, a spin coating method, or a slit coating method.

At step 1220, a reactive liquid crystal layer can be coated on the alignment layer 11. In some embodiments, the reactive liquid crystal can be dissolved in an organic solvent. The organic solvent can be coated on the alignment layer 11 by a continuous roll coating method or a batch coating method. The organic solvent can be evaporated to form the reactive liquid crystal layer. The quality of the reactive liquid crystal can be from about 20% P to about 30% by mass of the organic solvent.

At step 1230, the reactive liquid crystal molecules in the reactive liquid crystal layer can be aligned for a first time, so that the orientation of the reactive liquid crystal molecules can be parallel to a surface of the alignment layer 11.

In some embodiments, the reactive liquid crystal layer can be irradiated with a linearly polarized ultraviolet light, so that the orientation of the reactive liquid crystal molecules can be parallel to the surface of the alignment layer 11. A wavelength of the linearly polarized ultraviolet light can be in a range from about 300 nm to about 370 nm.

At step 1240, the reactive liquid crystal molecules in the reactive liquid crystal layer can be aligned for a second time, so that the orientation of portions of the reactive liquid crystal molecules can be perpendicular to a surface of the alignment layer 11.

In some embodiments, an electric field perpendicular to the alignment layer 11 can be applied to a partial region of the reactive liquid crystal layer, so that the orientation of the portions of the reactive liquid crystal molecules in the partial region of the reactive liquid crystal layer can be perpendicular to the surface of the alignment layer 11.

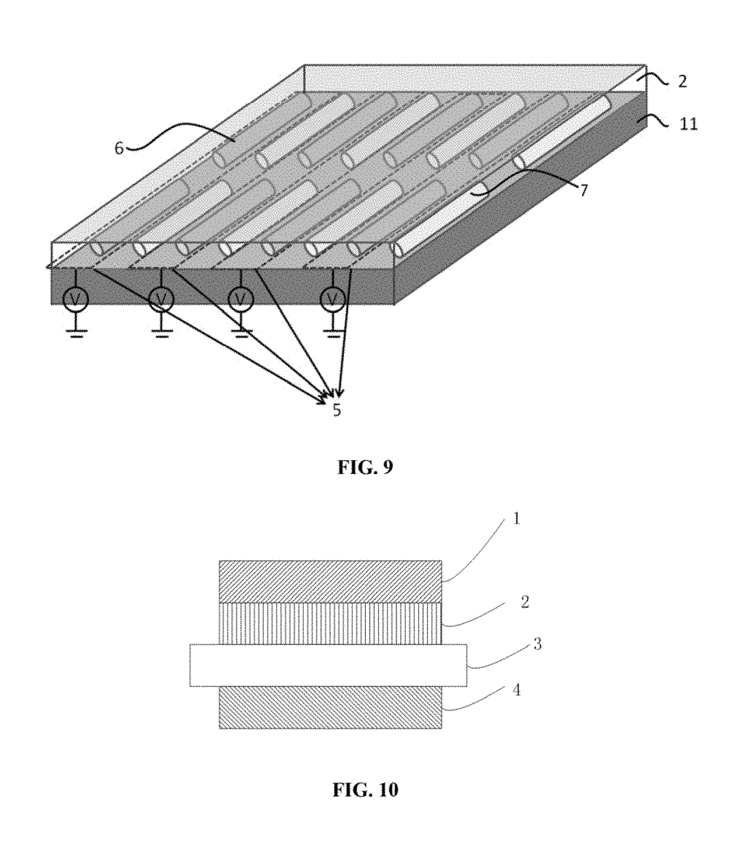

FIG. 9 shows a schematic structural diagram of an exemplary retardation film in a certain fabricating stage when an alignment of reactive liquid crystal molecules is to be adjusted in accordance with some embodiments of the present disclosure.

As illustrated, in some embodiments, the partial region of the reactive liquid crystal layer to be applied by the electric field can include multiple sub-regions 5 that are arranged at intervals. In some embodiments, the sub-regions 5 of the reactive liquid crystal layer to be applied by the electric field can be uniformly separated by multiple of spaced-regions of the reactive liquid crystal layer 2 that are not to be applied by the electric field.

The application of the electric field perpendicular to the alignment layer 1 can cause the orientation of the length axes of the reactive liquid crystal molecules 6 in the multiple sub-regions 5 of the reactive liquid crystal layer to be aligned as a direction that is perpendicular to the surface of the alignment layer 11 in the cubic plane. That is, the orientation of the length axes of the reactive liquid crystal molecules 6 in the multiple sub-regions 5 that are applied by the electric field can be perpendicular to the orientation of the length axes of the reactive liquid crystal molecules 7 in the spaced-regions of the reactive liquid crystal layer that are not applied by the electric field.

In some embodiments, the electric field can be applied by using slit electrodes. The voltage of the electric field can be equal to or higher than a saturation voltage of the reactive liquid crystal, thereby ensuring that the orientation of the reactive liquid crystal molecules 6 in the multiple sub-regions 5 of the reactive liquid crystal layer to be aligned as a direction that is perpendicular to the surface of the alignment layer 11 in the cubic plane, and is approximately perpendicular to the orientation of the reactive liquid crystal molecules 7 in the multiple spaced-regions of the reactive liquid crystal layer in the cubic plane. In some embodiments, the intensity of the electric field can be from about 4V to about 7V.

Turning back to FIG. 12, at step 1250, the alignment of the reactive liquid crystal can be fixed to obtain a liquid crystal polymer layer 2. In some embodiments, the alignment of the reactive liquid crystal can be fixed by performing an ultraviolet curing process at a constant temperature.

In some embodiments, the constant temperature can be within a range from about 100° C. to about 130° C. In order to prevent the reactive liquid crystal from reacting with oxygen in the air, the ultraviolet curing process can be performed in nitrogen. Under the constant temperature and the ultraviolet irradiation, the reactive liquid crystal molecules can be polymerized, and the orientation of the reactive liquid crystal molecules can be fixed.

At step 1260, the retardation film including the alignment layer 11 and the liquid crystal polymer layer 2 can be bonded.

When the substrate is a glass substrate or a quartz substrate, the liquid crystal polymer layer 2 of the retardation film can be first bonded to the triacetate (TAC) layer of the polarizer adjacent to the liquid crystal panel, and then the alignment layer 11 of the retardation film can be bonded to the liquid crystal panel.

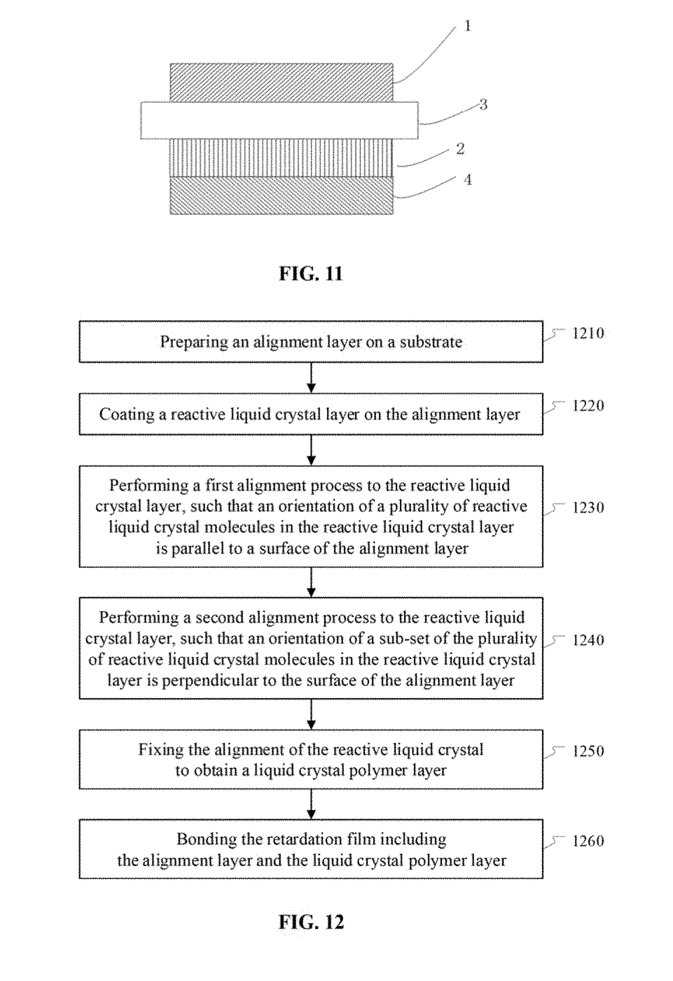

Referring to FIGS. 10 and 11, schematic structural diagrams of exemplary display devices are shown in accordance with various embodiments of the present disclosure. As illustrated, the display device can include an upper polarizer 1, a lower polarizer 4, a liquid crystal display panel 3, and a retardation film 2.

In some embodiments, the liquid crystal display panel 3 can be located between the upper polarizer 1 and the lower polarizer 4. The retardation film 2 can be the disclosed retardation film 2 described above.

In some embodiments as shown in FIG. 10, the retardation film 2 can be located between the upper polarizer 1 and the liquid crystal display panel 3. The direction of the absorption axis of the upper polarizer can be perpendicular to the orientation of liquid crystal molecules in the liquid crystal panel. The direction of the absorption axis of the lower polarizer can be parallel to the orientation of liquid crystal molecules in the liquid crystal panel.

In some alternative embodiments as shown in FIG. 11, the retardation film 2 can be located between the liquid crystal display panel 3 and the lower polarizer 4. The direction of the absorption axis of the upper polarizer can be parallel to the orientation of liquid crystal molecules in the liquid crystal panel. The direction of the absorption axis of the lower polarizer can be perpendicular to the orientation of liquid crystal molecules in the liquid crystal panel.

It should be noted that, the orientation of liquid crystal molecules in the liquid crystal panel can be the direction of the alignment of the liquid crystal molecules in the liquid crystal panel.

Further, the disclosed retardation film can be suitable for compensation of the oblique viewing angle of the display devices in advanced super dimension switching (ADS) mode, in-plane switching (IPS) mode, or fringe-field switching (FFS) mode.

In order to further understand the disclosed retardation film, the disclosed fabricating method thereof, and the disclosed display device, two examples are described in details according to some embodiments without limiting the scope of the present disclosure.

In the first example, a polyvinyl alcohol having a modified property by a water-transporting group can be coated on a substrate by using a gravure coating method, a wire coating method, a spin coating method, or a slit coating method. The coated polyvinyl alcohol can then be dried to form an alignment layer.

The reactive liquid crystal represented by formula I can be dissolved in an organic solvent. The organic solvent can then be coated on the alignment layer by using a continuous roll coating method or a batch coating method. Next, the organic solvent can be evaporated to obtain a reactive liquid crystal layer. The quality of the reactive liquid crystal can be about 20% to about 30% of the mass of the organic solvent.

The reactive liquid crystal layer can be irradiated with a linearly polarized ultraviolet light, so that the orientation of the reactive liquid crystal molecules can be parallel to the surface of the alignment layer. In some embodiments, the wavelength of the ultraviolet light can be 300 nm to 370 nm.

Using the slit electrodes, an electric field in a vertical direction can be applied to the sub-regions 5 as shown in FIG. 9, such that the orientation of the reactive liquid crystal molecules in the sub-regions 5 can be perpendicular to the surface of the alignment layer in the cubic plane. Then, the reactive liquid crystal molecules in the sub-regions 5 can be brought into an equilibrium state in the vertical direction while maintaining the electric field constant.

An ultraviolet irradiation can be carried out at about 100° C. to about 130° C. in a nitrogen environment to polymerize the reactive liquid crystal molecules, and to fix the alignment of the vertically oriented and horizontally oriented reactive liquid crystal molecules. As such, a liquid crystal polymer layer 2 can be obtained.

After peeling off the substrate, the liquid crystal polymer layer 2 of the prepared retardation film can be bonded to the triacetate (TAC) layer of the upper polarizer adjacent to the liquid crystal display panel by a roll-to-roll process. Then, the prepared upper polarizer can be bonded to the liquid crystal display panel. The other side of the liquid crystal panel can be bonded to the lower polarizer.

In the disclosed display device in the first example, the absorption axis direction of the upper polarizer can be perpendicular to the orientation of the liquid crystal molecules in the liquid crystal display panel, and the absorption axis direction of the lower polarizer can be parallel to the orientation of the liquid crystal molecules in the liquid crystal panel. The alignment angle of the liquid crystal molecules in the liquid crystal display panel can be set as 90 degrees.

In the second example, a polyvinyl alcohol having a modified property by a water-transporting group can be coated on a substrate by using a gravure coating method, a wire coating method, a spin coating method, or a slit coating method. The coated polyvinyl alcohol can then be dried to form an alignment layer.

The reactive liquid crystal represented by formula I can be dissolved in an organic solvent. The organic solvent can then be coated on the alignment layer by using a continuous roll coating method or a batch coating method. Next, the organic solvent can be evaporated to obtain a reactive liquid crystal layer. The quality of the reactive liquid crystal can be about 20% to about 30% by mass of the organic solvent.

The reactive liquid crystal layer can be irradiated with a linearly polarized ultraviolet light, so that the orientation of the reactive liquid crystal molecules can be parallel to the surface of the alignment layer. In some embodiments, the wavelength of the ultraviolet light can be about 300 nm to about 370 nm.

Using the slit electrodes, an electric field in a vertical direction can be applied to the sub-regions 5 as shown in FIG. 9, such that the orientation of the reactive liquid crystal molecules in the sub-regions 5 can be perpendicular to the surface of the alignment layer in the cubic plane. Then, the reactive liquid crystal molecules in the sub-regions 5 can be brought into an equilibrium state in the vertical direction while maintaining the electric field constant.

An ultraviolet irradiation can be carried out at about 100° C. to about 130° C. in a nitrogen environment to polymerize the reactive liquid crystal molecules, and to fix the alignment of the vertically oriented and horizontally oriented reactive liquid crystal molecules. As such, a liquid crystal polymer layer 2 can be obtained.

After peeling off the substrate, the liquid crystal polymer layer 2 of the prepared retardation film can be bonded to the TAC layer of the lower polarizer adjacent to the liquid crystal display panel by a roll-to-roll process. Then, the prepared lower polarizer can be bonded to the liquid crystal display panel. The other side of the liquid crystal panel can be bonded to the upper polarizer.

In the disclosed display device in the second example, the absorption axis direction of the upper polarizer can be parallel to the orientation of the liquid crystal molecules in the liquid crystal display panel, and the absorption axis direction of the lower polarizer can be perpendicular to the orientation of the liquid crystal molecules in the liquid crystal panel. The alignment angle of the liquid crystal molecules in the liquid crystal display panel can be set as 90 degrees.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, a retardation film, a fabricating method thereof, and a related display device are provided.

Although the present disclosure has been described and illustrated in the foregoing illustrative embodiments, it is understood that the present disclosure has been made only by way of examples, and that numerous changes in the details of embodiment of the present disclosure can be made without departing from the spirit and scope of the present disclosure, which is only limited by the claims which follow. Features of the disclosed embodiments can be combined and rearranged in various ways. Without departing from the spirit and scope of the present disclosure, modifications, equivalents, or improvements to the present disclosure are understandable to those skilled in the art and are intended to be encompassed within the scope of the present disclosure.

1. A retardation film, comprising:
an alignment layer; and
a liquid crystal polymer layer on the alignment layer and formed by polymerizing and curing reactive mesogens, the reactive mesogens including a plurality of reactive liquid crystal molecules having perpendicular orientations.

2. The retardation film of claim 1, wherein:
an orientation of a first portion of the plurality of reactive liquid crystal molecules is parallel to a surface of the alignment layer; and
an orientation of a second portion of the plurality of reactive liquid crystal molecules is perpendicular to the surface of the alignment layer.

3. The retardation film of claim 1, wherein:
a material of the alignment layer is polyvinyl alcohol or polyimide.

4. The retardation film of claim 1, wherein:
each reactive liquid crystal molecule includes a polymerizable group, and a rod-shaped liquid crystal group or a plate-shaped liquid crystal group.

5. The retardation film of claim 1, wherein:
each reactive liquid crystal molecule includes a plurality of rod-shaped liquid crystal groups that are directly connected to each other, or connected with each other via linking groups.

6. The retardation film of claim 5, wherein:
the plurality of rod-shaped liquid crystal groups include one or more aromatic groups or cycloaliphatic groups.

7. The retardation film of claim 1, wherein:
each reactive liquid crystal molecule includes an end group and at least one side group; and
the end group and the at least one side groups are selected from divalent carbon groups, hydrocarbyl groups, polar groups, nitro groups, hydroxyl groups, and polymerizable groups.

8. The retardation film of claim 2, wherein:
the first portion of the plurality of reactive liquid crystal molecules are located in a plurality of first regions of the liquid crystal polymer layer;
the second portion of the plurality of reactive liquid crystal molecules are located in a plurality of second regions of the liquid crystal polymer layer; and
the first regions and the second regions are arranged alternatively.

9. The retardation film of claim 2, wherein:
a summation of a thickness of the alignment layer and the liquid crystal polymer layer is between 2 μm and 5 μm.

10. A method for fabricating a retardation film, comprising:
preparing an alignment layer on a substrate;
coating a reactive liquid crystal layer on the alignment layer;
performing a first alignment process to the reactive liquid crystal layer, such that an orientation of a plurality of reactive liquid crystal molecules in the reactive liquid crystal layer is parallel to a surface of the alignment layer;
performing a second alignment process to the reactive liquid crystal layer, such that an orientation of a sub-set of the plurality of reactive liquid crystal molecules in the reactive liquid crystal layer is perpendicular to the surface of the alignment layer; and
fixing the alignment of the reactive liquid crystal to form a liquid crystal polymer layer, on the alignment layer.

11. The method of claim 10, wherein the first alignment process includes:
irradiating the reactive liquid crystal layer by a linearly polarized ultraviolet light to align the orientation of the reactive liquid crystal molecules to be parallel to the surface of the alignment layer.

12. The method of claim 10, wherein the second alignment process includes:
applying an electric field perpendicular to the alignment layer to a partial region of the reactive liquid crystal layer including the sub-set of the plurality of reactive liquid crystal molecules, such that the orientation of the sub-set of the plurality of reactive liquid crystal molecules is perpendicular to the surface of the alignment layer.

13. The method of claim 12, wherein:
the electric field is applied by using a plurality of silt electrodes; and
an intensity of the electric field is equal to or higher than a saturation voltage of the reactive liquid crystal.

14. The method of claim 13, wherein:
the intensity of the electric field is within a range from about 4V to about 7V.

15. The method of claim 10, wherein fixing the alignment of the reactive liquid crystal includes:
performing an ultraviolet curing process at a constant temperature to fix the alignment of the reactive liquid crystal.

16. The method of claim 15, wherein:
the constant temperature is within a range from about 100° C. to about 130° C.

17. The method of claim 15, wherein:
the ultraviolet curing process is performed in a nitrogen environment.

18. A display device, comprising:
an upper polarizer;
a lower polarizer;
a liquid crystal display panel between the upper polarizer and the lower polarizer; and
a retardation film between the upper polarizer and the lower polarizer, the retardation film including:
an alignment layer, and
a liquid crystal polymer layer on the alignment layer and formed by polymerizing and curing reactive mesogens, the reactive mesogens including a plurality of reactive liquid crystal molecules having perpendicular orientations.

19. The display device of claim 18, wherein:
the retardation film is between the upper polarizer and the liquid crystal display panel;
a direction of an absorption axis of the upper polarizer is perpendicular to the orientations of liquid crystal molecules in the liquid crystal panel; and
a direction of an absorption axis of the lower polarizer is parallel to the orientations of liquid crystal molecules in the liquid crystal panel.

20. The display device of claim 18, wherein:
the retardation film is between the lower polarizer and the liquid crystal display panel;
a direction of an absorption axis of the upper polarizer is parallel to the orientations of liquid crystal molecules in the liquid crystal panel; and
a direction of an absorption axis of the lower polarizer is perpendicular to the orientations of liquid crystal molecules in the liquid crystal panel.
